(19) United States
(12) Patent Application Publication
(10) Pub. No.: US 2003/0061453 A1
(43) Pub. Date: Mar. 27, 2003

(54) Method and apparatus for arbitrating a memory bus

(76) Inventors: Jason E. Cosky, San Francisco, CA (US); John A. Morelli, Milpitas, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/965,387

(22) Filed: Sep. 27, 2001

(51) Int. Cl. G06F 13/00

(52) U.S. Cl. 711/154

(57) ABSTRACT

A method and apparatus comprising initializing a circuit, said circuit having at least one memory element coupled to a memory bus, on a host system (e.g., a computer system). Monitoring signals on the memory bus of the host system, detecting a first sequence of signals, and switching control of the at least one memory element to the circuit coupled to the memory bus on the host system. The method and apparatus further comprises detecting a second sequence of signals, and switching control of the at least one memory element to the host system.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### BACKGROUND OF THE INVENTION

1. Field of the Invention

The present invention is related to the field of electronics. In particular, the present invention is related to a method and apparatus for arbitrating a memory bus.

2. Description of the Related Art

In computer systems there exists a need for processing large amounts of data in the shortest possible time. One method to satisfy this need is through the use of a peripheral component interconnect (PCI) architecture. Using PCI architecture PCI devices may access a processor on a host machine using a low latency path. FIG. 1 illustrates an example of PCI architecture I 100, wherein a host machine 101 comprising processor 105, chipset 115 (e.g., Intel's 430HX PCI chipset), and memory 130 (e.g., synchronous dynamic random access memory (SDRAM)) is coupled to PCI bus 110 via the chipset 115. Also coupled to the PCI bus 110 are processing elements such as an audio/video card 120 and a SCSI card 125.

When a processing element on PCI bus 110 such as the audio/video card 120 needs to use the host system memory, the processing element on the PCI bus accesses the host system memory via the chipset. Accessing the host system memory via the chipset slows down the processing of information.

By having the processing element reside on the memory bus instead of the PCI bus and arbitrating the memory bus, thereby processing information simultaneously with the processing of information by a processor on a host system, a significant decrease in processing time is realized (i.e., the bandwidth of the host system is increased). In addition, PCI bus constraints are significantly reduced as fewer elements compete with each other for the use of the PCI bus. Furthermore, processing of certain algorithms may be shifted from processing by the host processor to processing by the processing element.

### BRIEF SUMMARY OF THE DRAWINGS

Examples of the present invention are illustrated in the accompanying drawings. The accompanying drawings, however, do not limit the scope of the present invention. Similar references in the drawings indicate similar elements.

FIG. 1 illustrates a prior art PCI bus architecture.

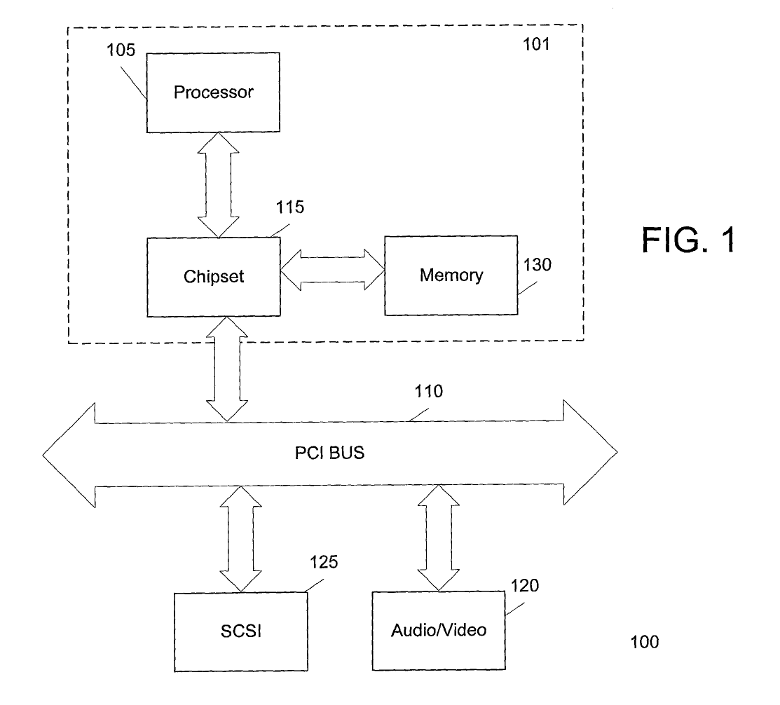

FIG. 2 illustrates computer architecture according to one embodiment of the invention.

FIG. 3 illustrates a memory bus arbiter according to one embodiment of the invention.

FIG. 4 illustrates a state machine for switching the local memory bus according to one embodiment of the invention.

FIG. 5 illustrates a valid memory access detection scheme according to one embodiment of the invention.

FIG. 6 illustrates an initializing circuit for initializing a processing element according to one embodiment of the invention.

FIG. 7 is a block diagram of a computer system according to one embodiment of the invention.

### DETAILED DESCRIPTION OF THE INVENTION

Described is a method and apparatus arbitrating a memory bus according to one embodiment of the invention. In the following description, numerous specific details are set forth in order to provide a thorough understanding of the present invention. It will be apparent, however, to one of ordinary skill in the art that the present invention may be practiced without these specific details. In other instances, well-known architectures, steps, and techniques have not been shown to avoid unnecessarily obscuring the present invention. For example, specific details are not provided as to whether the method is implemented in a transmitter, receiver, equalizer, modem, as a software routine, hardware circuit, firmware, or a combination thereof.

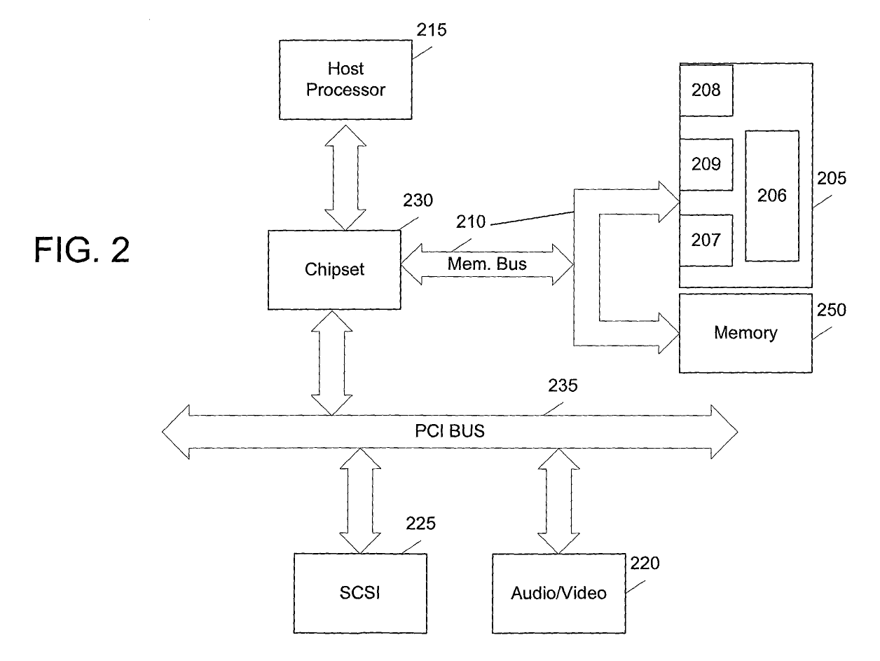

FIG. 2 illustrates computer architecture according to one embodiment of the invention. As illustrated in FIG. 2, processing element 205 is coupled with a host processor 215 via host memory bus 210. Processing element 205 includes an FPGA processor 208, a memory controller 209, an arbiter 207, and on board memory 206. The on board memory 206 is coupled with host memory bus 210 via a local memory bus (i.e., a memory bus locally disposed within processing element 205). The local memory bus can be switched to allow for FPGA processor 208, via memory controller 209, to access the on board memory 206, or for host processor 215, via at least host memory bus 210, to access the on board memory 206. System memory 250 may be used for processing by host processor 215 concurrently with the processing of information by processing element 205. In addition, FIG. 2 illustrates other processing elements such as audio/video card 220 and SCSI card 225 coupled to processor 215 via chipset 230 and PCI bus 235.

Although the embodiment of FIG. 2 illustrates one processing element 205 with on board memory 206 coupled with host memory bus 210 of host processor 215, alternate embodiments may have more than one processing element coupled with the host memory bus of the host processor. With multiple processing elements, a main arbiter (e.g., an arbiter on one of the processing elements, or even on a separate stand-alone arbiter circuit) controls the switching of each local memory bus between each processing element and the host memory bus of the host processor. In this embodiment, each processing element may process information concurrently with each other and with host processor 215.

Parts of the description will be presented using terminology commonly employed by those skilled in the art to convey the substance of their work to others skilled in the art. Also, parts of the description will be presented in terms of operations performed through the execution of programming instructions. As well understood by those skilled in the art, these operations often take the form of electrical, magnetic, or optical signals capable of being stored, transferred, combined, and otherwise manipulated through, for instance, electrical components.

In addition, it should be understood that the programs, processes, method, etc. described herein are not related or limited to any particular computer or apparatus nor are they related or limited to any particular communication network architecture. Rather, various types of general purpose machines may be used with program modules constructed in accordance with the teachings described herein. Similarly, it may prove advantageous to construct a specialized apparatus to perform the method steps described herein by way of dedicated computer systems in a specific network architecture with hard-wired logic or programs stored in nonvolatile memory such as read only memory.

Various operations will be described as multiple discrete steps performed in turn in a manner that is helpful in understanding the present invention. However, the order of description should not be construed as to imply that these operations are necessarily performed in the order they are presented, or even order dependent. Lastly, repeated usage of the phrase “in one embodiment” does not necessarily refer to the same embodiment, although it may.

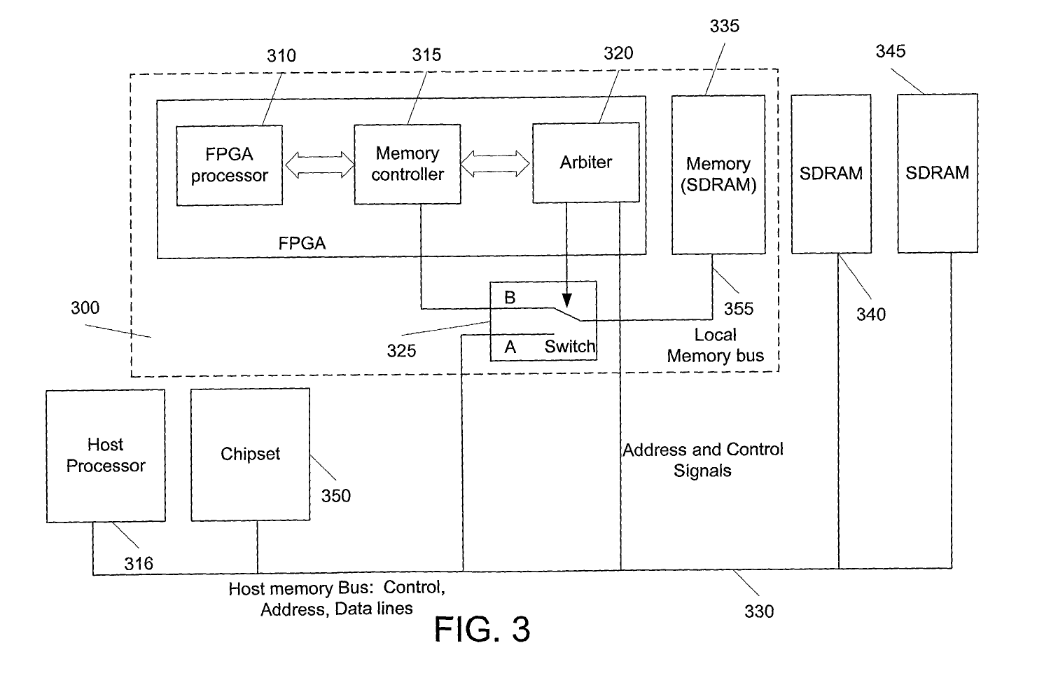

FIG. 3 illustrates a memory bus arbiter according to one embodiment of the invention. As FIG. 3 illustrates, in one embodiment, processing element 300 comprises at least a field programmable gate array (FPGA) 305, switch 325, and memory elements 335. Processing element 300 may be installed either as part of a host computer system (e.g., as a dual inline memory module (DIMM)) on a memory slot on the host computer system, or as an external device that is detachable from the host computers memory bus. FPGA 305 comprises a memory controller 315 that is communicatively coupled with FPGA processor 310 and with arbiter 320. Arbiter 320, via the processing element device driver software, controls switch 325, and continuously monitors at least the control and address signals on host memory bus 330. Arbiter 320 continuously monitors at least these signals on the host memory bus regardless of the position of switch 325.

Switch 325 switches local memory bus 355 from communicating with memory controller 315 (under the control of FPGA processor 310) to communicating with host processor 316, via chipset 350, and vice versa i.e., switch 325 couples memory elements (e.g., a SDRAM bank) 335 to either, host memory bus 330, or to memory controller 315. Host processor 316 on the host computing system, via chipset 350, controls SDRAM bank 335 when switch 325 is in position A. In switch position A, host processor 316 controls not only SDRAM bank 335 but also other SDRAM banks 340 and 345 that are externally disposed with processing element 300 on the host computer system. Prior to initializing processing element 300, switch 325 is in position A, and the host processor has access to SDRAM 335 on processing element 300, and views processing element 300 as a SDRAM bank. When processing element 300 is initialized, the host processor 316 recognizes the processing element as a module capable of processing information concurrently with host processor 316.

When switch 325 is in position B, FPGA processor 310 via memory controller 315 controls access to SDRAM bank 335, and may use SDRAM bank 335 for processing. In one embodiment, while FPGA processor 310 processes information, (e.g., under instructions from host processor 316) host processor 316 may use SDRAM banks 340 and 345 to process data concurrently with the FPGA processor. This concurrent processing of information significantly speeds up the processing capabilities of the host computer system.

Arbiter 320, on processing element 300, interprets memory accesses performed by the processing element device driver software and switches control of SDRAM bank 335 between the FPGA processor 310 and the host processor 316. In particular, arbiter 320 switches local memory bus 355 between position A and position B of switch 325. The processing element device driver software reserves memory elements (i.e., particular memory addresses on SDRAM bank 335) and monitors these memory addresses for a read or write in order to either switch control of local memory bus 355 or to initialize processing element 300. In one embodiment, the reserved memory elements are locally disposed on processing element 300. In other embodiments, the reserved memory elements are remotely disposed on the host computing system. In still other embodiments, the reserved memory elements are disposed both locally on the processing element as well as remotely on the host computer system. The reserved memory elements are used to ensure that the operating system or some other application does not inadvertently switch the position of switch 325.

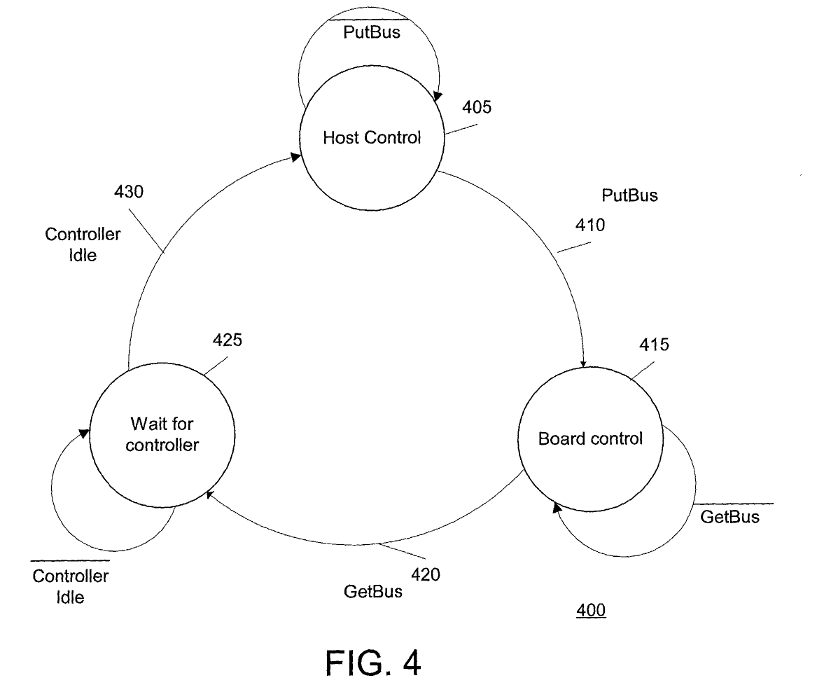

FIG. 4 illustrates a state machine for switching the local memory bus according to one embodiment of the invention. At boot-up of the host computing system, switch 325 is in position A and the host processor 316 has control of local memory bus 355 and SDRAM 335. This is illustrated as 405 in state machine 400.

At 410, arbiter 320 detects a PutBus command, (i.e., a command to put the FPGA processor 310 in control of local memory bus 355) and state machine 400 switches the local memory bus 355 to position B. In position B, at 415 FPGA processor 310 via memory controller 315 has control of local memory bus 355. State machine 400 remains in this state, i.e., with FPGA processor 310 in control of the local memory bus 355 until state machine 400 detects a GetBus command at 420 (i.e., a command to switch control of local memory bus 355 to the host processor).

When the GetBus command is detected state machine 400 sends a signal to FPGA processor 310 and in particular to memory controller 315 to switch the local memory bus 355 to position A. In position A, host processor 316 has control of local memory bus 355 and of SDRAM bank 335. State machine 400, at 425 waits for the memory controller to complete the task it is currently processing (e.g., reading from, writing to, or refreshing the SDRAM bank) prior to switching local memory bus 355 to position A. After memory controller 315 completes the task it is processing, and optionally refreshes SDRAM bank 335, memory controller 315 sends a Controller_Idle signal at 430, (indicating that the memory controller 315 is idle) to arbiter 320. On receiving the Controller_Idle signal, arbiter 320 switches local memory bus 335 to position A, and host processor 316 gains control of the local memory bus and SDRAM bank 355.

Bus arbitration, i.e., the control of switch 325 and in particular the control of local memory bus 355 comprises three functions: initializing processing element 300, switching control of local memory bus 355 to FPGA processor 310, and switching control of local memory bus 355 to the host processor 316. Arbiter 320 in conjunction with processing element device driver software performs these three functions using switch 325.

The initializing of processing element 300 is performed by the initialization function of the processing element device driver software. The initialization function (INIT) informs processing element 300 that a device driver and, in particular, a user program intends using the processing element. The INIT function is run once per session, a session being defined as the time during which the host computer system is booted up and running. The INIT function is a sequence of eight SDRAM reads or writes, or a combination of reads and writes, to various addresses of the reserved memory elements. In one embodiment, there may be other SDRAM accesses (e.g., memory refreshes) in between the INIT function reads or writes. However, the SDRAM reads or writes to the reserved memory addresses must occur in a particular predefined sequence. Once processing element 300 is initialized, the local memory bus 355 may be switched between processing element 300, and the host processor 316 or vice versa.

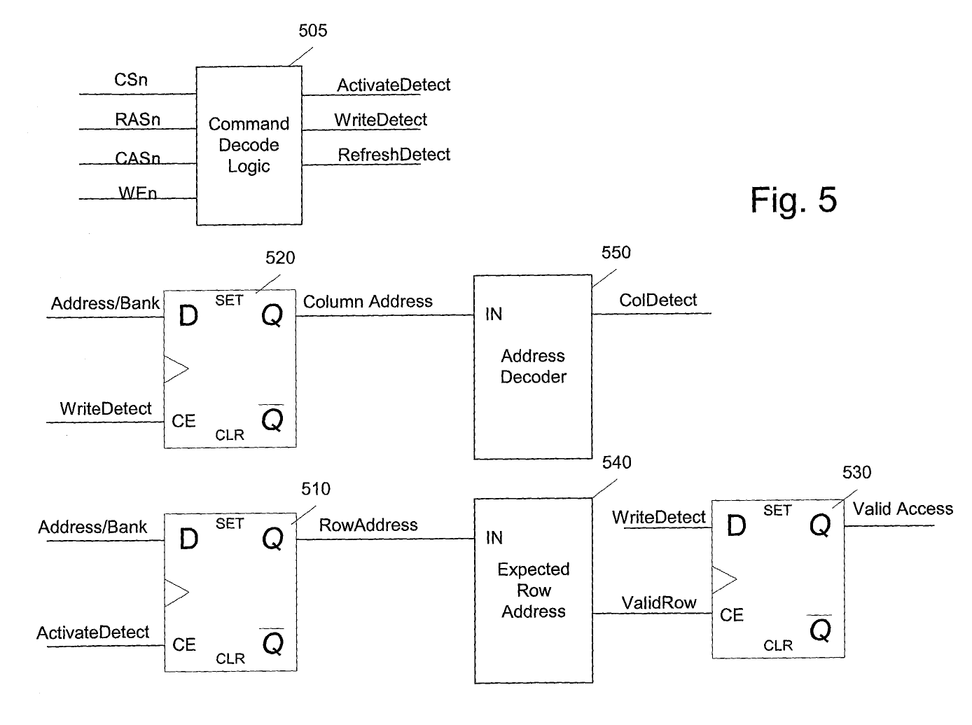

FIG. 5 illustrates a valid memory access detection scheme according to one embodiment of the invention. In particular, FIG. 5 illustrates a SDRAM write cycle detection scheme, wherein the arbiter 320 detects writes to the reserved memory addresses. The reserved memory addresses are memory addresses that are set aside by the processing element device driver software so as to either enable the switching of local memory bus 355 or to commence the initializing of processing element 300. Arbiter 320, on processing element 300, comprises command decode logic 505, flip-flops 510, 520 and 530, comparator 540, and address decoder 550. Command decode logic 505 detects chip select (CSn), row address select (RASn), column address select (CASn), and write enable (WEn) commands for the particular reserved memory addresses in SDRAM 335, and outputs an ActivateDetect, a WriteDetect, or a RefreshDetect signal once an activate, write, or refresh command to any on board memory address is detected. One skilled in the art will appreciate that only one of the outputs of command decode logic 505 will be active at any given time. Furthermore, for a valid SDRAM memory access, a row within a bank of SDRAM is first activated followed by writing to a column of SDRAM within that particular row and bank. For each ActivateDetect signal, the address and bank signals are latched as a RowAddress by flip-flop 510. The RowAddress lines output by flip-flop 510 are input into comparator 540, and compared by comparator 540 with the reserved row and bank address for the desired function (i.e., for the PutBus, GetBus, or INIT functions). Once the ValidRow signal is output by comparator 540, indicating that the activate is to the reserved row of memory, arbiter 320 waits for Command decode Logic 505 to indicate a write (i.e., WriteDetect=1) to any on board memory address. The ValidRow signal output by comparator 540 is connected to the chip enable (CE) input of flip-flop 530.

When a write to any on board memory address is detected, the address and bank signals are captured as a ColumnAddress by flip-flop 520. If the RowAddress is still valid, a ValidAccess signal is asserted at the output of flip-flop 530. Address decoder 550 decodes the ColumnAddress signal at the output of flip-flop 520. On detection of the appropriate column, the Arbiter performs the requested operation (i.e., PutBus, GetBus, or INIT). However, in the case of the INIT operation the arbiter waits for the next address in the sequence of addresses. Only when the particular sequence of addresses is detected is processing element 300 initialized.

For example, if address P, comprised of row R, bank B, and column C, is reserved to indicate switching local memory bus 355 from position A to position B (i.e., the PutBus function), then if the value of the RowAddress lines output by flip-flop 510 equals the value of row R and bank B, a ValidRow signal is output by comparator 540. Following a write to a memory address, if the value of the ColumnAddress lines output by flip-flop 520 equals the value of column C and bank B, then, the appropriate ColDetect signal is asserted. If the row address for P is still valid, a ValidAccess signal is asserted. This assertion of ValidAccess and ColDetect (C) indicates a PutBus function (i.e., a command to switch the local memory bus 355 from position A to position B).

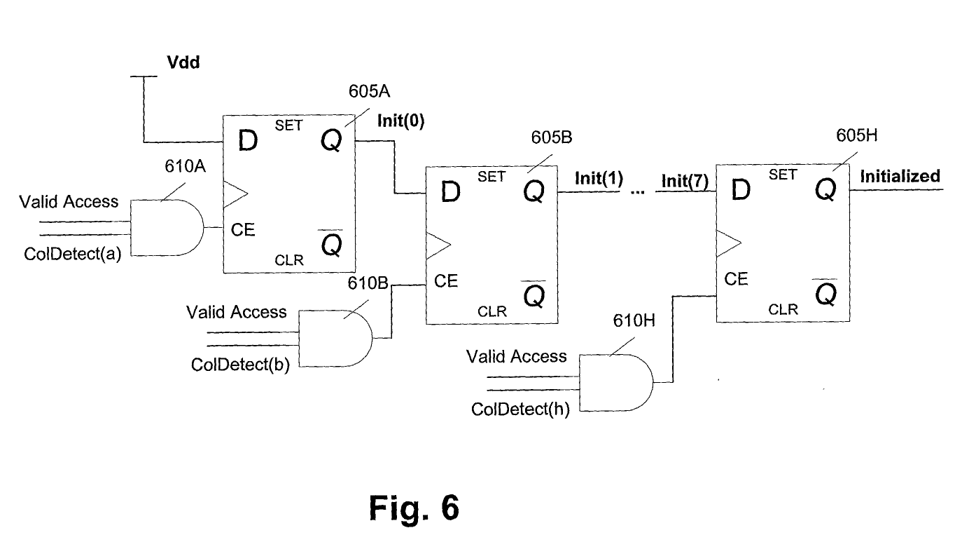

FIG. 6 illustrates an initializing circuit for initializing a processing element according to one embodiment of the invention. As illustrated in FIG. 6, initializing circuit 600 comprises eight flip-flops 605A-H. Each flip-flop has its output Q connected to the D input of the adjacent flip-flop with the exception of flip-flop 605A whose D input is connected to Vdd (e.g., a power supply voltage). Each flip-flop 605A-H has a two input AND gate 610A-H, with inputs P and Q, connected to each of the CE inputs of flip-flops. Each P input of the AND gate has the ValidAccess signal coupled from the output of flip-flop 530 of FIG. 5. When a valid ColDetect signal, corresponding to the first of eight reserved INIT addresses, from the output of address decoder 550 of FIG. 5, is input into input Q of AND gate 610A, the output of AND gate 610A goes high (i.e., a logic 1), and flip-flop 605A latches the Vdd signal present at the D input of flip-flop 605A. This causes the value Init(0) at output Q of flip-flop 605A to be a high (logic 1). The process of detecting writes to particular column addresses continues, as stated above, until each of the eight flip-flops 605A-H have a high (logic 1) present at the Q output. When the Q outputs of the eight flip-flops 605A-H are high, processing element 300 initialized.

As stated earlier, switching control of local bus 355 to FPGA processor 310, and in particular to memory controller 315 is achieved using a PutBus function. The PutBus function is a SDRAM read or write to a particular memory location in the reserved memory element address space. Upon detection of the read or write to the particular address (i.e., an address reserved for the PutBus function), arbiter 320 switches local memory bus from position A to position B (see FIG. 3) putting memory controller 315 in control of the bus. In one embodiment, the ValidAccess signal at the output of flip-flop 530 and the proper ColDetect signal at the output of address decoder 550 of FIG. 5, and the initialized signal at the output of flip-flop 605H of FIG. 6 are input into a three input AND gate, and when the output of the AND gate is a logic 1, arbiter 320 switches the local memory bus from switch position A to position B. Thus the logic for switching local memory bus 355 from position A to position B has been described. One skilled in the art will realize that similar logic may be employed to switch local memory bus 355 from position B to position A.

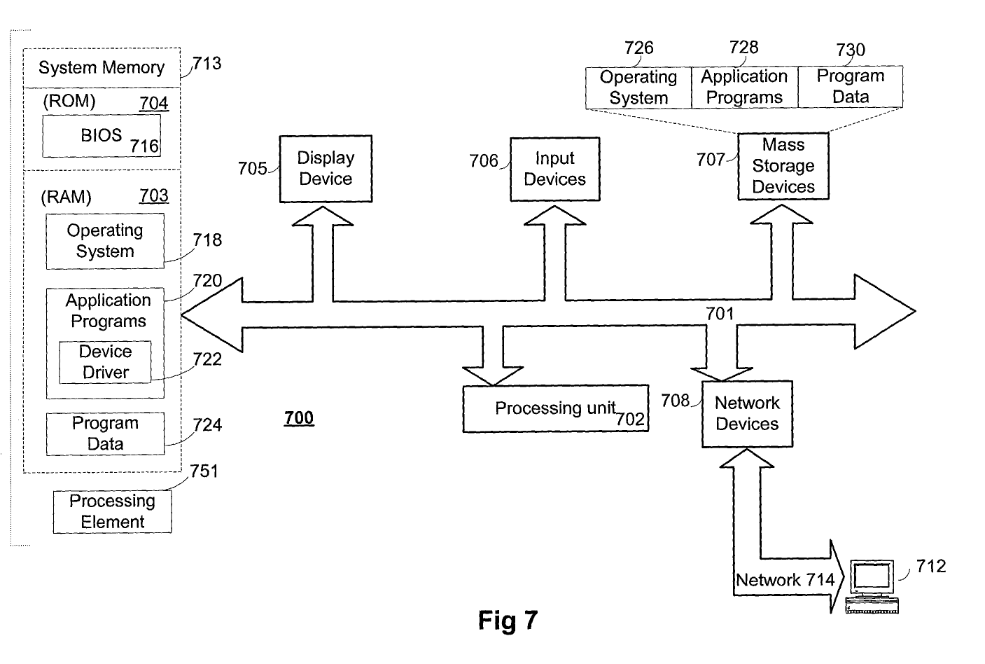

FIG. 7 is a block diagram of a computer system according to one embodiment of the invention. In general, such computer systems as illustrated in FIG. 7 include a processing unit 702 coupled through a bus 701 to a system memory 713. System memory 713 comprises a read only memory (ROM) 704, and a random access memory (RAM) 703. ROM 704 comprises Basic Input Output System (BIOS) 716, and RAM 703 comprises operating system 718, Application programs 720, processing element device driver software 722, and program data 724.

Display device 705 is coupled to processor 702 through bus 701 and provides graphical output for computer system 700. Input devices 706 such as a keyboard or mouse are coupled to bus 701 for communicating information and command selections to processor 702. Also coupled to processor 702 through bus 701 is an input/output interface (not shown) which can be used to control and transfer data to electronic devices (printers, other computers, etc.) connected to computer system 700. Computer system 700 includes network devices 708 for connecting computer system 700 to a remote device such as a router, gateway, or other computing device 712 via network 714. Network devices 708, may include Ethernet devices, phone jacks and satellite links. It will be apparent to one of ordinary skill in the art that other network devices may also be utilized.

In one embodiment, as illustrated in FIG. 7, processing element 751 is coupled to the memory bus of computer system 700. The on board memory of processing element 751 is coupled with the memory bus of computer system 700 via a switch that couples the local memory bus (i.e., a memory bus locally disposed within processing element 751) with the memory bus of computer system 700. The local memory bus can be switched to allow for an FPGA processor via a memory controller on processing element 751 to access the on board memory of processing element 751, or for processing unit 702, via at least the memory bus, to access the on board memory of processing element 751. Switching of the local memory bus on processing element 751 is achieved via an arbiter that is locally disposed on processing element 751. RAM 703 may be used for processing by processing unit 702 concurrently with the processing of information by processing element 751.

One embodiment of the invention may be embedded in a hardware product, for example, in a printed circuit board, in a special purpose processor, or in a specifically programmed logic device communicatively coupled to the memory bus of computer system 700. Other embodiments of the invention may include a combination of a hardware product and software product. For example, the processing element may be embedded in a hardware product, and the device driver software may be a software product.

Embodiments of the invention may be represented as a software product stored on a machine-accessible medium (also referred to as a computer-accessible medium or a processor-accessible medium). The machine-accessible medium may be any type of magnetic, optical, or electrical storage medium including a diskette, CD-ROM, memory device (volatile or non-volatile), or similar storage mechanism. The machine-accessible medium may contain various sets of instructions, code sequences, configuration information, or other data. Those of ordinary skill in the art will appreciate that other instructions and operations necessary to implement the described invention may also be stored on the machine-accessible medium. Thus the machine-accessible medium includes instructions for initializing a circuit said circuit having at least one memory element coupled to a memory bus on a host system, monitoring signals on the memory bus, detecting a first sequence of signals, and switching control of the at least one memory element to the circuit when the first sequence of signals (e.g., a PutBus signal) is detected. The machine-accessible medium includes further instructions for detecting a second sequence of signals (e.g., a GetBus signal), and switching control of the at least one memory element to the host system when the GetBus signal is detected. The processing of information by the circuit is concurrent with the processing of information by the host system.

Thus a method and apparatus have been disclosed for arbitrating a memory bus. While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

What is claimed is:

1. A method comprising:
initializing a circuit said circuit having at least one memory element coupled to a memory bus on a host system;
monitoring signals on the memory bus;
detecting a first sequence of signals; and
switching control of the at least one memory element to the circuit.

2. The method of claim 1 further comprising:
detecting a second sequence of signals; and
switching control of the at least one memory element to the host system

3. The method of claim 2 wherein error correcting codes are switched off prior to switching control of the at least one memory element to the host system.

4. The method of claim 1 wherein initializing a circuit having at least one memory element coupled to a memory bus on a host system comprises detecting a sequence of writes to memory locations on the circuit.

5. The method of claim 4 wherein the sequence of writes are writes to random memory locations on the circuit.

6. The method of claim 1 wherein monitoring signals on the memory bus comprises the circuit monitoring control, address, and data signals on the host system.

7. The method of claim 1 wherein detecting a first sequence of signals comprises detecting at least one write signal to a particular memory location on the circuit.

8. The method of claim 1 wherein detecting a first sequence of signals comprises detecting at least one read signal from a particular memory location on the circuit.

9. The method of claim 1 wherein switching control of the memory bus to the circuit comprises a processing element in the circuit reading from or writing to the memory in the circuit.

10. The method of claim 2 wherein switching control of the at least one memory element to the host system comprises a processor on the host system reading from or writing to the at least one memory element.

11. An apparatus comprising:
a memory bus on a host system;
a plurality of memory elements on a circuit, said plurality of memory elements communicatively coupled with the memory bus;
a processing element on the circuit communicatively coupled with the plurality of memory element and the memory bus, said processing element to
monitor signals on the memory bus;
detect a first sequence of signals; and
switch control of the plurality of memory elements to the circuit.

12. The apparatus of claim 11 further comprising said processing element to detect a second sequence of signals; and switch control of the plurality of memory elements to the host system.

13. The apparatus of claim 12 wherein error correcting codes are switched off prior to switching control of the plurality of memory element to the host system.

14. The apparatus of claim 11 wherein the processing element is at least one of a field programmable gate array, and a processor.

15. The apparatus of claim 11 wherein the processing element to monitor signals on the memory bus comprises the processing element to monitor control, address, and data signals on the host system.

16. The apparatus of claim 11 wherein the processing element to detect a first sequence of signals comprises the processing element to detect at least one write signal to a particular memory element on the circuit.

17. The apparatus of claim 11 wherein the processing element to detect a first sequence of signals comprises the processing element to detect at least one read signal to a particular memory element on the circuit.

18. The apparatus of claim 11 wherein the processing element to switch control of the plurality of memory element to the circuit comprises the processing element reading from or writing to the plurality of memory elements.

19. The apparatus of claim 12 wherein the processing element to switch control of the plurality of memory elements to the circuit comprises a processor on the host system reading from or writing to the plurality of memory elements.

20. An article of manufacture comprising:
a machine-accessible medium including instructions that, when executed by a machine, causes the machine to perform operations comprising
initializing a circuit said circuit having at least one memory element coupled to a memory bus on a host system;
monitoring signals on the memory bus;
detecting a first sequence of signals; and switching control of the at least one memory element to the circuit.

21. The article of manufacture as in claim 20, further comprising instructions for detecting a second sequence of signals; and
switching control of the at least one memory element to the host system.

22. The article of manufacture as in claim 21, further comprising instructions for switching of error correcting codes prior to switching control of the at least one memory element to the host system.

23. The article of manufacture as in claim 20, wherein said instructions for initializing a circuit having at least one memory element coupled to a memory bus on a host system comprises further instructions for detecting a sequence of writes to memory locations on the circuit.

24. The article of manufacture as in claim 23, wherein said instructions for detecting a sequence of writes include further instructions for writing to random memory locations on a circuit.

25. The article of manufacture as in claim 20, wherein said instructions for monitoring signals on the memory bus comprises further instructions for the circuit monitoring control, address, and data signals on the host system.

26. The article of manufacture as in claim 20, wherein said instructions for detecting a first sequence of signals comprises further instructions for detecting at least one write signal to a particular memory location on the circuit.

27. The article of manufacture as in claim 20, wherein said instructions for detecting a first sequence of signals comprises further instructions for detecting at least one read signal from a particular memory location on the circuit.

28. The article of manufacture as in claim 20, wherein said instructions for switching control of the memory bus to the circuit comprises further instructions for a processing element in the circuit reading from or writing to the memory in the circuit.

29. The article of manufacture as in claim 21, wherein said instructions for switching control of the at least one memory element to the host system comprises further instructions for a processor on the host system reading from or writing to the at least one memory element.
